(19) United States
(12) Patent Application Publication
(10) Pub. No.: US 2001/0040143 A1
(43) Pub. Date: Nov. 15, 2001

(54) Method for extracting sodium elements from glass surface

(76) Inventors: Hong Kyu Jang, Seoul (KR); Chung-Nam Whang, Seoul (KR); Taek-Jung Shin, Seongnam-city (KR)

Correspondence Address: NIXON & VANDERHYE P.C., 8th Floor, 1100 North Glebe Rd., Arlington, VA, 22201-4714, US

(21) Appl. No.: 09/794,025

(22) Filed: Feb. 28, 2001

(30) Foreign Application Priority Data
Nov. 25, 1999 (KR) 1999-52772

(51) Int. Cl. B44C 1/22

(52) U.S. Cl. 216/31; 216/97; 216/108; 216/41

(57) ABSTRACT

A method for extracting sodium elements from a glass surface is provided. The method includes extracting sodium elements from the surface of glass by etching the Na containing glass substrate with strong acid. The corrosion of the glass surface can be prevented at low cost, without a change in the characteristics of glass materials. Also, an adhesive strength between glass and metal can be improved. Further, change in the characteristics of a deposited layer due to diffusion of sodium elements can be prevented.

### BACKGROUND OF THE INVENTION

1. Field of the Invention

The present invention relates to a method for producing glass, and more particularly, to a method for extracting sodium (Na) elements in glass surface.

2. Description of the Related Art

Currently, glass is generally produced in the following manner. That is, sand, soda lime, limestone, broken glass, etc. are mixed at an appropriate mixing ratio and the mixed materials are melted in a crucible at a high temperature of 1,450° C. or higher. Then, in order to improve the quality of glass, the melted glass materials are cleaned and then cooled to a temperature suitable for molding, and then slowly cooled down for relaxing the stress of the formed glassware. The glass, which is injected to a cooling chamber in a state in which the glass is still held at a high temperature, is slowly cooled to then be possessed with durability.

Sodium (Na) is added in the glass material to reduce the melting temperature during melting in glass production. In this case, however, the Na contained in the glass has the following disadvantages.

First, the sodium at the glass surface reacts with water vapor, causing degradation of glass transparency and durability and the failure of the insulated gate field-effect transistor.

Second, when metal is deposited on glass, adhesion between metal and glass is weakened. When glass is used under a high temperature condition, sodium is diffused into the glass surface to then react with materials deposited on the glass surface, in particular, oxide such as TiO₂ and ITO, deteriorating the characteristics of the deposited layer.

There is a known technology for maintaining the transparency of glass by eliminating the reaction between water vapor and sodium on the glass surface. A hot glass surface is exposed to air containing a small percentage of sulfuric dioxide and alkali metal such as sodium is removed from the glass surface. However, the sodium existing on the surface layer, that is, approximately 100 nm in depth from the surface, cannot be completely removed, still involving problems such as deterioration in the characteristic of the metal deposited layer or glass corrosion. One of attempts to overcome these problems is to form a diffusion barrier such as SiO₂ on the glass surface, to prevent the sodium in glass from reacting with the metal deposited layer due to diffusion. However, since the diffusion barrier forming process uses vacuum equipments such as e-beam evaporator, sputter, chemical vapor deposition (CVD), etc., the production cost is high and large-scale glass is difficult to treat.

In order to solve the problem of poor adhesive strength between the metal film and glass substrate occurring when the metal is deposited on glass, as the methods for increasing an adhesive strength between the metal thin film and the glass substrate, there is known a method for washing the glass substrate in an ultrasonic cleaner by using acetone, methanol, ethanol, etc., rinsing the same by using distilled water, and dehydrating the same in an oven having a filter for preventing dust from being introduced thereinto for more than one hour at about 200 εC.

Next, there is also known a method for washing and dehydrating in the same manner as in the previous method and depositing Cr, Ti, etc., which has a good adhesive strength with respect to the glass substrate, on the glass substrate to form a buffer layer and then depositing a metal on the resultant material.

However, the earlier method has a slightly increased adhesive strength but does not have a substantial adhesive strength under environment in which there are much friction and abrasion, and the later method has an advantage in that the adhesive strength is greatly increased but has a disadvantage in that since an additional metal such as Cr, Ti, etc., is used as a buffer layer, the metal of the buffer layer is diffused out onto the film formed on the deposited layer, thus forming a new phase. In this case, the characteristic of the material may be degraded due to unpredictable reasons.

In addition, there is an ion beam mixing method which is directed to forcibly mixing at a boundary formed between a substrate and a thin film. Since the method needs a high ion energy, a bulky apparatus such as an ion implanter or a Van der Graaf accelerator is required, so that it is difficult to actually use the above-described method. In particular, it is reported that increasing an adhesive strength with respect to Au and glass material by using this method, is almost impossible.

### SUMMARY OF THE INVENTION

To solve the above problems, it is an objective of the present invention to provide a method for effectively extracting sodium from glass at low cost, by which the durability of glass can be improved by suppressing the reaction between sodium and water vapor, an adhesive strength between a glass substrate and metal or ceramic deposited on the glass substrate and deterioration of a TiO₂ and ITO layer due to sodium out-diffusion can be prevented even at a high temperature.

Accordingly, to achieve the above objective, there is provided a method for extracting sodium (Na) elements from the surface of glass by etching the Na containing glass substrate with strong acid.

Preferably, the strong acid is at least one selected from the group consisting of sulfuric acid (H₂SO₄), nitric acid (HNO₃) and hydrochloric acid (HCl).

The etching is preferably performed by one of boiling, ultrasonic treatment and soaking, and the etching time is preferably in the range of 10 seconds to 10 hours.

The concentration of the strong acid is preferably in the range of 0.1 to 100% (w/w), that is, the concentration of the strong acid is not so meaningful a factor in increasing the extracting effect.

The treatment temperature may range from room temperature to 500° C. and the ultrasonic treatment is preferably performed for from 1 minute to 10 hours.

The surface of the glass substrate may be wrapped using a patterned mask to partially etch a desired portion.

### BRIEF DESCRIPTION OF THE DRAWINGS

The above objectives and advantages of the present invention will become more apparent by describing in detail a preferred embodiment thereof with reference to the attached drawings in which:

FIG. 1 is an X-ray Photoelectron Spectroscopy (XPS) spectrum occurring on a glass surface depending on chemical etching conditions in Example 1 of the present invention;

FIGS. 2A and 2B are graphs illustrating changes in the atomic concentrations of bare glass and glass which is chemically etched under the condition (c) in Example 1, respectively;

FIG. 3 shows three-dimensional (3D) images of a glass surface measured by an Atomic Force Microscope (AFM) depending on etching conditions in Example 1;

FIG. 4 is a graph showing Rₘₛ (root-mean-square) surface roughness calculated from the 3D images shown in FIG. 3;

FIG. 5A is a graph illustrating Si 2p XPS peaks on the surfaces of bare glass and glass treated under the condition (c) in Example 1, measured at a vacuum degree of 2×10⁻¹⁰ torr as a function of annealing temperature;

FIG. 5B is a graph illustrating O 1s XPS peaks on the surfaces of bare glass and glass treated under the condition (c) in Example 1, measured at a vacuum degree of 2×10⁻¹⁰ torr as a function of annealing temperature;

FIG. 5C is a graph illustrating Na 1s XPS peaks on the surfaces of bare glass and glass treated under the condition (c) in Example 1, measured at a vacuum degree of 2×10⁻¹⁰ torr as a function of annealing temperature;

FIG. 5D is a graph illustrating Al 2p XPS peaks on the surfaces of bare glass and glass treated under the condition (c) in Example 1, measured at a vacuum degree of 2×10⁻¹⁰ torr as a function of annealing temperature;

FIG. 5E is a graph illustrating S 2p XPS peaks on the surfaces of bare glass and glass treated under the condition (c) in Example 1, measured at a vacuum degree of 2×10⁻¹⁰ torr as a function of annealing temperature;

FIG. 6 is an X-ray Photoelectron Spectroscopy (XPS) spectrum occurring on a glass surface depending on chemical etching conditions in Example 2 of the present invention;

FIG. 7 shows 3D images of a glass surface measured by an AFM depending on etching conditions in Example 2;

FIG. 8 is a graph showing the relative transmittance of bare glass and chemically etched glass in Example 2;

FIGS. 9A and 9B are XPS survey spectra depending on annealing temperatures of bare glass and chemically etched glass under a condition (e) in Example 2;

FIG. 10 is an X-ray Photoelectron Spectroscopy (XPS) spectrum occurring on a glass surface depending on chemical etching conditions in Example 3 of the present invention;

FIG. 11 shows 3D images of a glass surface measured by an AFM depending on etching conditions in Example 3;

FIG. 12 is a graph showing the relative transmittance of bare glass and chemically etched glass in Example 3; and

FIG. 13 is an XPS survey spectrum depending on annealing temperatures of chemically etched glass under the condition (a) in Example 3.

### DESCRIPTION OF THE PREFERRED EMBODIMENTS

The present invention provides a glass substrate treatment method which can prevent deterioration of a TiO₂ layer due to diffusion of sodium in a glass substrate and can improve an adhesive strength between metal and a glass substrate, by suppressing the reaction between water vapor and sodium elements on the glass surface by extracting sodium elements from the glass substrate.

The method of the present invention includes a process of soaking processed glassware in an acidic solution having a predetermined concentration for a predetermined time. More preferably, the present invention may further include a heat treatment or ultrasonic treatment. In the glass substrate treatment method according to the present invention, the sodium elements can be effectively extracted from the glass surface at low cost.

Also, according to the present invention, since the glass surface to be treated can be partially etched in a desired pattern by wrapping the glass surface with a patterned mask and then etching, only a desired portion of the glass surface can be etched to a desired depth. Thus, the present invention can be applicable in various ways.

The present invention will now be described in more detail with reference to preferred embodiments. Unless otherwise noted, all the percent (%) used throughout the specification are by weight (w/w).

### EXAMPLE 1

Chemical Etching with Sulfuric Acid (H₂SO₄

The glass samples used in this experiment, that is, slide glass (Marienfeld Co.), are glass substrates having a rectangular shape (0.2 mm×12 mm×12 mm). The glass substrates were chemically etched under the following conditions:

s: bare glass (no treatment)

a: Boiling in 50% H₂SO₄ solution for 30 minutes;

b: Ultrasonic treatment in 50% H₂SO₄ solution for 30 minutes;

c: Boiling in 95% H₂SO₄ solution for 30 minutes;

d: Soaking in 50% H₂SO₄ solution for 6 hours; and

e: Soaking in 95% H₂SO₄ solution for 6 hours.

X-ray Photoelectron Spectroscopy (XPS) measurements were carried out to investigate a compositional change of the glass surface depending on chemical etching conditions. The XPS measurements were performed under an ultrahigh vacuum atmosphere at a base pressure of 2×10⁻¹⁰ torr using a concentric hemispherical analyzer with an energy resolution of 0.48 eV, Al Ka (hν=1486.6 eV) X-ray source and an X -ray monochromator.

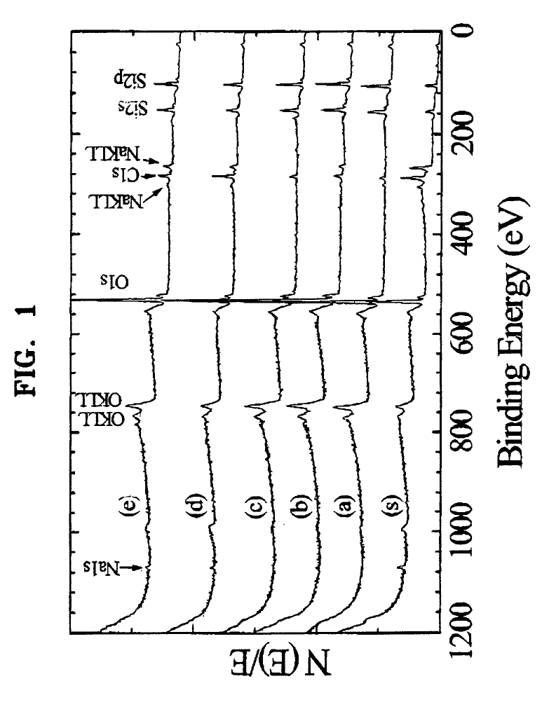

FIG. 1 is an X-ray Photoelectron Spectroscopy (XPS) spectrum analysis of a glass surface chemically etched under the above-described five conditions and a bare glass (s).

As shown in FIG. 1, while the sample of bare glass (being under the condition (s)) showed higher peaks of sodium (Na) and carbon (C) relative to silicon (Si), all the samples chemically etched with H₂SO₄ showed that the heights of C and Na peaks were greatly reduced relative to Si peak. In particular, no sodium signal was detected from the sample surface being under the condition (c) in which the sample was boiled in 95% H₂SO₄ solution at 293° C. for 30 minutes.

Table 1 shows atomic compositions (atomic percentage) of the glass surface estimated from the XPS spectrum shown in FIG. 1 using XPS sensitivity factors. Since Fe and Ca elements contained in glass in small amounts are within the noise level to be barely distinguishable from noise in the XPS spectrum, their compositions were difficult to obtain. The sodium content in the surface of bare glass under the condition (s) was approximately 2.7%, while no sodium content (0%) was measured in the surface of etched glass under the conditions (a)-(c), that is, when boiled in 50% and 95% H₂SO₄ solutions for 30 minutes, which means that sodium elements were effectively eliminated from the glass surface.

TABLE 1
Atomic composition of the Glass surface as a function of chemical
etching conditions with H₂SO₄

| Sample No. | C | O | Na | Si |
|---|---|---|---|---|
| s | 44.6 | 37.1 | 2.7 | 15.7 |
| a | 13.4 | 60.7 | 0 | 25.9 |
| b | 15.4 | 58.6 | 0 | 26.0 |
| c | 11.9 | 63.0 | 0 | 25.1 |
| d | 33.1 | 47.0 | 0.5 | 19.4 |
| e | 17.9 | 56.3 | 0.9 | 24.9 |

In general, sodium is added to glass in order to reduce the melting temperature of glass materials mixed in the course of melting in glass production and more than 10% Na₂O is added to most glassware. However, since sodium is highly concentrated in the bulk rather than in the glass surface and out-diffusion of sodium elements occurs in the course of XPS analysis due to surface contamination and an intrinsic volatile property of sodium, the measured sodium content was presumably smaller than the actual sodium content.

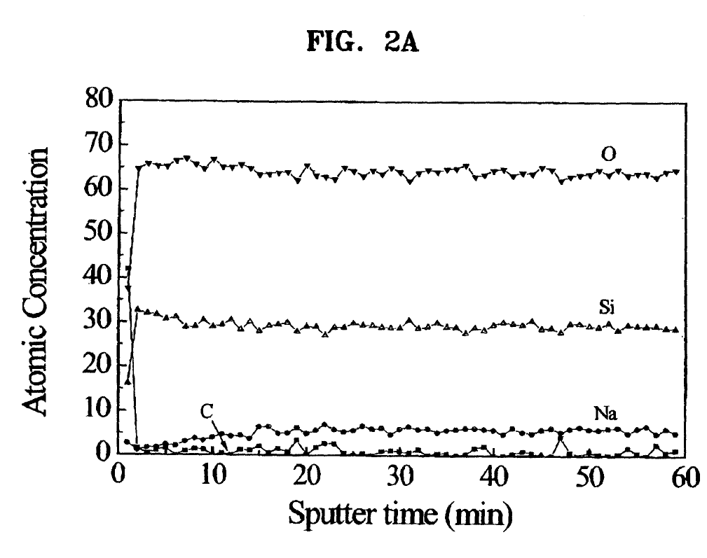

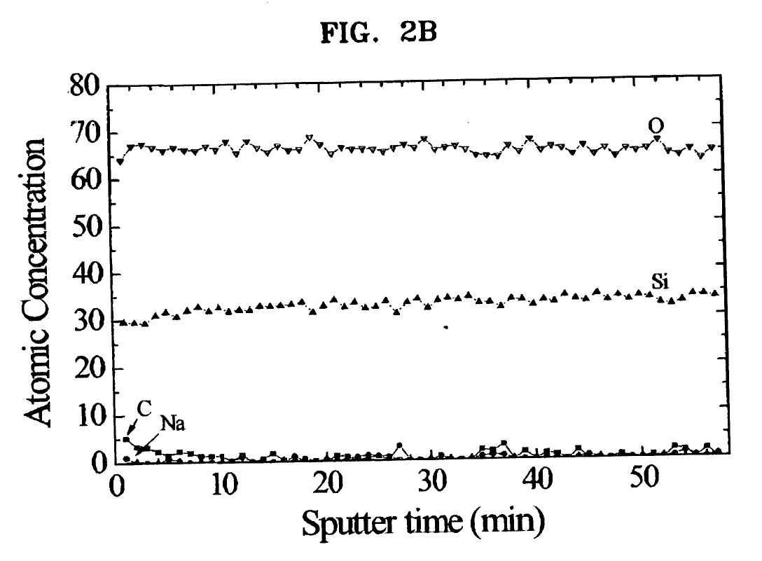

FIG. 2A illustrates the depth profile of bare glass being under the condition(s) and glass which is chemically etched under the condition (c) in which the sample was boiled in 95% H₂SO₄ for 30 minutes, measured to obtain the glass composition depending on the depth. The XPS depth profile was obtained by sputtering at a time interval of one minute with 3 keV Ar⁺ ion beams.

As shown in FIG. 2A, a considerable amount of carbon was present in the bare glass being under the condition (s) and sodium concentration in the surface of the bare glass was found to be 2.7%. The sodium concentration increased according to the depth and approached up to 6.3% or higher. However, as shown in FIG. 2B, in the sample being under the condition (c), that is, the sample boiled in 95% H₂SO₄ for 30 minutes, sodium elements were not observed at the glass surface nor at the surface level of the glass sputtered down for 55 minutes. In other words, sodium was extracted in a considerable depth, that is, approximately 100 nm from the surface, as well as in the surface of glass sample boiled in 95% H₂SO₄ for 30 minutes, that is, under the condition (c). The same result was obtained in the sample boiled in 50% H₂SO₄ for 30 minutes, that is, under the condition (a).

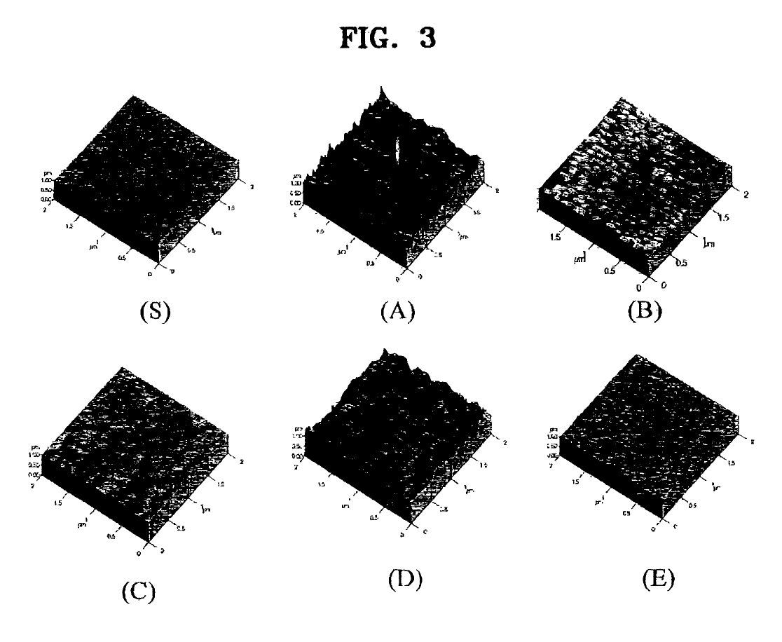

In order to study the structural change of the surface of chemically etched glass, AFM was employed. FIG. 3 shows three-dimensional (3D) images of a chemically etched glass surface, measured by an Atomic Force Microscope (AFM) usable in the atmosphere. As shown in FIG. 3, the glass boiled in 50% H₂SO₄ for 30 minutes, that is, under the condition (a), and the glass soaked in 50% H₂SO₄ for 6 hours, that is, under the condition (d), were etched so as to have considerably rough surfaces. On the other hand, the glass subjected to ultrasonic treatment in 50% H₂SO₄ for 30 minutes, that is, under the condition (b), the sample soaked in 95% H₂SO₄ for 30 minutes, that is, under the condition (c), and the sample soaked in 95% H₂SO₄ for 6 hours, that is, under the condition (e), had quite smooth surfaces.

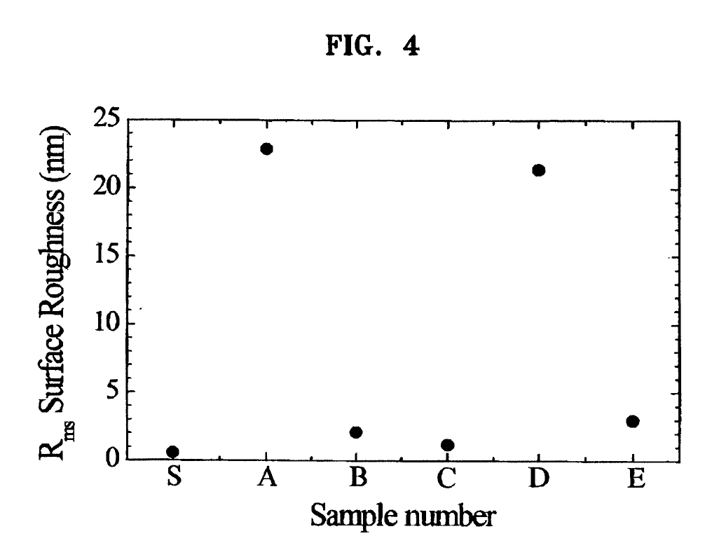

FIG. 4 is a graph showing the dependence of Rₘₛ surface roughness calculated from the 3D images shown in FIG. 3 on chemical etching condition. While the Rₘₛ surface roughness of bare glass, that is, under the condition (s) was 5.8 Å, the Rₘₛ surface roughness of the glass samples under the conditions (a), (b), (c), (d) and (e) were 229 Å, 21.0 Å, 119 Å, 214 Å and 29.8 Å, respectively. These large changes in surface roughness may be explained as follows. A solution of 50% H₂SO₄ is more reactive whit glass than 95% H₂SO₄. And the surface of the glass sonicated for 30 min in 50% H₂SO₄ is smoother than that of glass boiled for 30 min or soaked for 6 h at room temperature in 50% H₂SO₄.

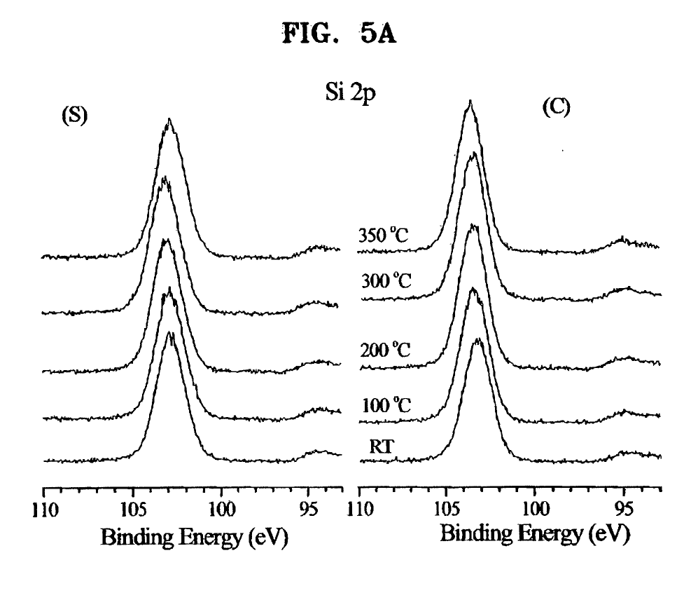

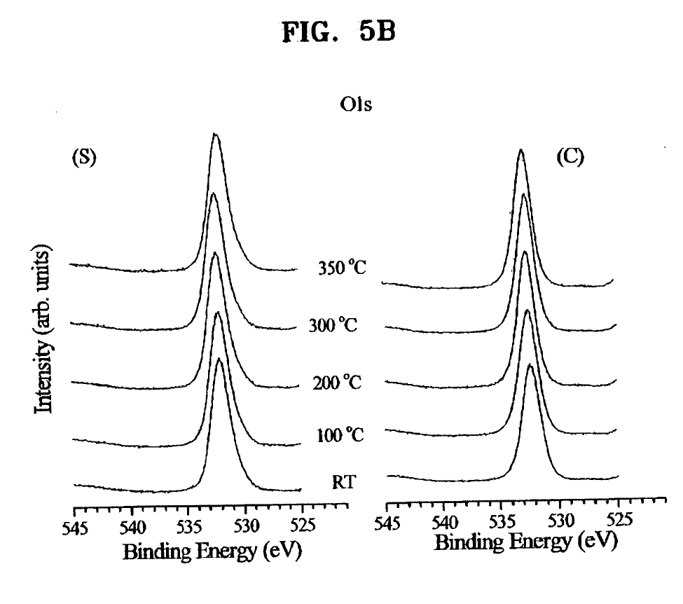

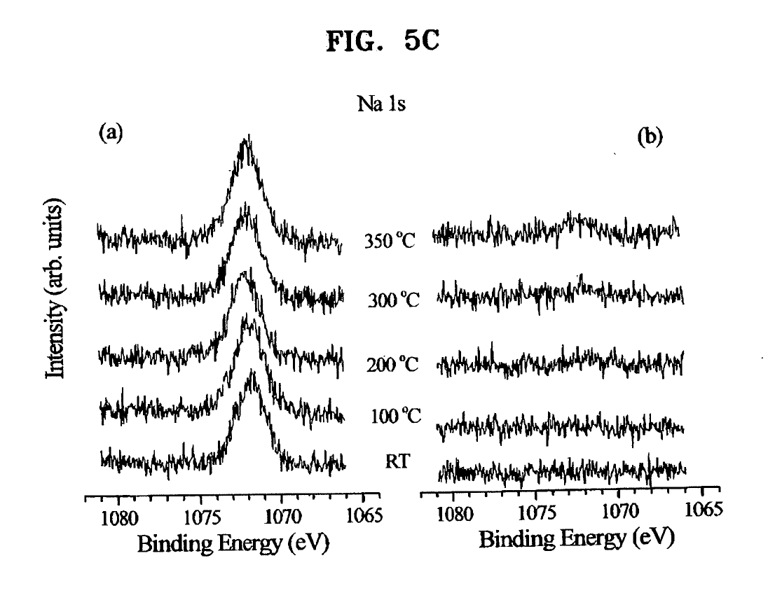

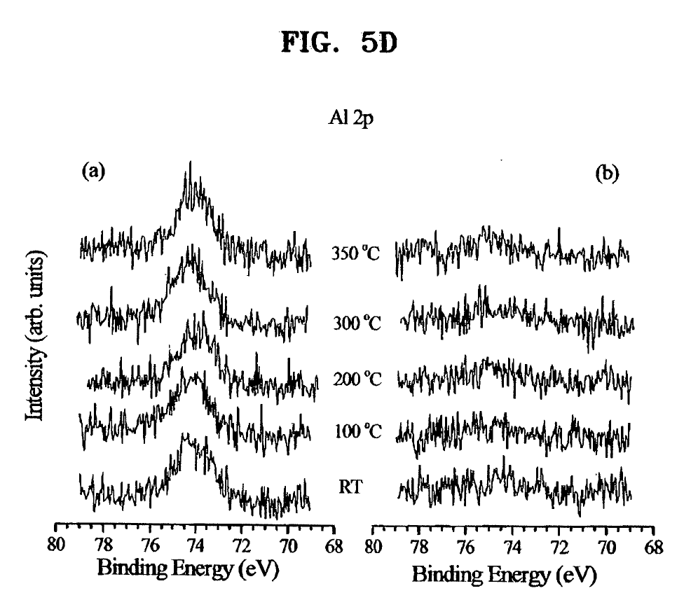

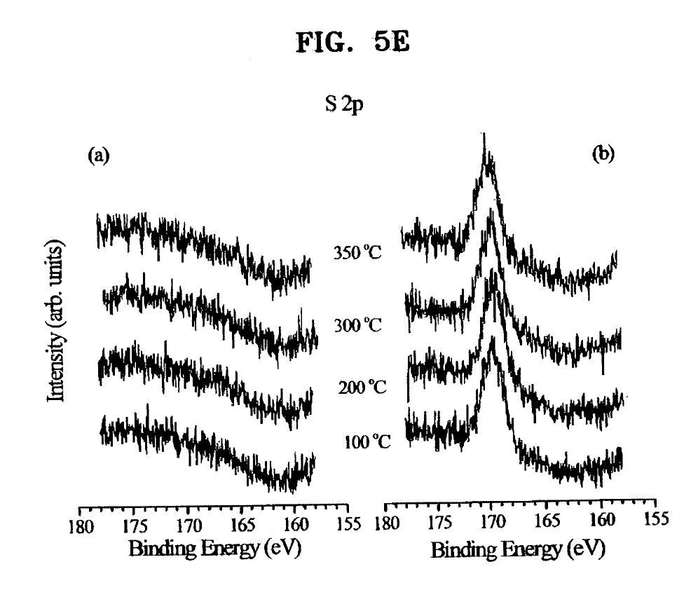

In order to investigate thermal stability of etched glass, the bare glass (s) and the glass boiled in 95% H₂SO₄ for 30 min (c) were annealed up to 350° C. in the XPS analysis chamber. Isochronal anneals were done in 20° C. steps with a 20 min anneal duration at each temperature. Annealing under five different temperature conditions have been studied: room temperature, 100° C., 200° C., 300° C., and 350° C. We took the XPS core-level lines of Si 2p_{3/2}, N 1s, O 1s, C 1s, Na 1s, Al 2p, Ca 2p, and S 2p, to obtain the atomic composition at the glass surface. FIGS. 5a-5e show the XPS spectra of of Si 2p, O 1s, Na 1s, Al 2p, and S 2p, respectively.

FIGS. 5A and 5B show the temperature dependent change of the peaks of Si and O, which are main elements of the glass. There was no considerable difference in the Si and O peaks depending on the temperatures before and after chemical etching treatments, that is, between the conditions (s) and (c).

FIG. 5C shows the XPS peak of sodium (Na). In FIG. 5C, while the Na 1s XPS peak was distinctly observed in the bare glass under the condition (s), the Na 1s XPS peak of the glass boiled in 95% H₂SO₄ for 30 minutes, that is, under the condition (c), was barely detectable not only at room temperature but also at 350° C.

In other words, even if the temperature of glass was raised, out-diffusion of sodium elements did not occur.

FIG. 5D illustrates the XPS peak of aluminum (Al) added to glass. It was understood from FIG. 5d that Al elements, like Na elements, were also effectively removed from the glass surface by chemical etching treatment. Further, even if the temperature of the glass surface was raised, little out-diffusion of Al elements occurred.

FIG. 5E illustrates the XPS peak of sulfur (S) [symbol] . Since S is not contained in the bare glass at all, no S peak was observed. However, in the glass boiled in 95% H₂SO₄ for 30 minutes, that is, under the condition (c), S 2p XPS peaks were detected not only at room temperature but also at 350° C., which was attributed to diffusion of S contained in H₂SO₄ used as an etching solution into the glass. Sulfur exists only on the glass substrate and disappears by sputtering using 3 keV Ar⁺ ion beams for 30 seconds.

Tables 2 and 3 summarize compositional changes of the surface of bare glass being under the condition (s) and the glass sample boiled in 95% H₂SO₄ for 30 minutes, that is, under the condition (c), estimated from XPS peaks using XPS sensitivity factors, depending on the annealing temperature, respectively. The percent (%) used herein is atomic percentage.

TABLE 2
Compositional changes of the glass surface of bare glass as a function of
annealing temperature

| | C | N | O | Na | Al | Si | Ca | Cl | S |
|---|---|---|---|---|---|---|---|---|---|
| Room temperature | 19.1 | 0.6 | 51.3 | 2.0 | 0.7 | 25.7 | 0.7 | 0 | 0 |
| 100° C. | 14.8 | 0 | 54.3 | 4.0 | 1.5 | 24.8 | 0.6 | 0 | 0 |
| 200° C. | 12.4 | 0 | 57.8 | 2.3 | 0.8 | 26.3 | 0.4 | 0 | 0 |
| 300° C. | 12.4 | 0 | 55.8 | 2.6 | 2.0 | 26.6 | 0.7 | 0 | 0 |
| 350° C. | 10.3 | 0 | 56.4 | 3.2 | 1.6 | 27.4 | 1.1 | 0 | 0 |

TABLE 3
Compositional changes of the surface of glass boiled in 95% H₂SO₄ for
30 minutes as a function of annealing temperature

| | C | N | O | Na | Al | Si | Ca | Cl | S |
|---|---|---|---|---|---|---|---|---|---|
| Room temperature | 23.1 | 0 | 51.3 | 0 | 0 | 23.9 | 0 | 0 | 1.7 |
| 100° C. | 13.4 | 0 | 57.1 | 0.3 | 0 | 26.1 | 0.3 | 0 | 2.9 |
| 200° C. | 16.5 | 0 | 54.3 | 0 | 0 | 26.2 | 0.1 | 0 | 2.8 |
| 300° C. | 15.4 | 0 | 55.5 | 0 | 0 | 26.2 | 0 | 0 | 3.0 |
| 350° C. | 14.9 | 0 | 56.4 | 0.1 | 0 | 25.9 | 0 | 0.2 | 2.6 |

As shown in Table 2, Na content in the surface of the bare glass was approximately 2% under the condition (s) and increased with an increase in the temperature due to diffusion. Al added to the glass in a small amount also showed the same increasing tendency.

However, as shown in Table 3, Na, Al and Ca contents were almost removed from the surface of the glass boiled in 95% H₂SO₄ for 30 minutes, that is, under the condition (c). Even if the annealing temperature increased up to 350° C., Na, Al and Ca elements in the glass surface were not detected. S elements diffused from H₂SO₄ into the glass were approximately 1.7% in the glass surface at room temperature, and then out-diffused with an increase in the annealing temperature to thus increase to 2.6-3.2%.

### EXAMPLE 2

Chemical Etching with Nitric Acid (HNO₃)

The glass samples used in this experiment, that is, slide glass (Marienfeld Co.), are glass substrates having a rectangular shape (0.2 mm×12 mm×12 mm) as in Example 1. The glass substrates were chemically etched under the following conditions:

s: No treatment

a: Soaking in 50% HNO₃ solution at room temperature for 6 hours;

b: Soaking in 70% HNO₃ solution at room temperature for 6 hours;

c: Ultrasonic treatment in 50% HNO₃ solution for 30 minutes;

d: Boiling in 50% HNO₃ solution for 30 minutes; and

e: Boiling in 50% HNO₃ solution for 30 minutes.

X-ray Photoelectron Spectroscopy (XPS) measurements were carried out to investigate a compositional change of glass depending on chemical etching conditions.

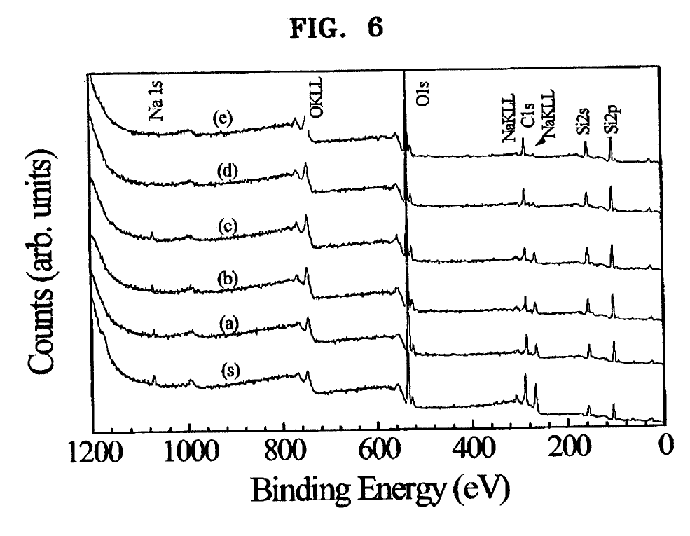

FIG. 6 is an X-ray Photoelectron Spectroscopy (XPS) spectrum showing the analysis results of compositions of the surfaces of bare glass and glass chemically etched under the above five conditions. As shown in FIG. 6, while the sample of bare glass (being under the condition (s)) showed higher peaks of sodium (Na) and carbon (C) relative to silicon (Si), all the samples chemically etched with HNO₃ showed that the heights of C and Na peaks were greatly reduced relative to Si peak. In particular, no sodium signal was detected from the sample surface being under the conditions (d) and (e) in which the sample was boiled in 50% and 70% HNO₃ solutions for 30 minutes, respectively.

Table 4 shows compositions of the surfaces of bare glass and glass chemically etched with HNO₃, estimated from XPS peaks thereof using XPS sensitivity factors. In Table 4, the nominal condition means the contents of materials injected in glass production, which are represented by atomic percentages.

TABLE 4
Atomic composition of glass surface depending on
HNO₃ treatment conditions

| | C | O | Na | Mg | Al | Si | Ca | Fe |
|---|---|---|---|---|---|---|---|---|
| s(No | 52.5 | 29.2 | 2.7 | 0 | 1.2 | 12.6 | 0.3 | 0 |
| treatment) | | | | | | | | |
| a | 24.7 | 45.9 | 2.3 | 0 | 0.6 | 25.3 | 0.6 | 0 |
| b | 13.9 | 54.2 | 1.8 | 0 | 1.0 | 28.6 | 0.4 | 0 |
| c | 13.1 | 51.7 | 2.0 | 0 | 0.8 | 30.9 | 0.3 | 0 |
| d | 17.5 | 52.7 | 0.3 | 0 | 0.4 | 28.5 | 0.2 | 0 |
| e | 20.1 | 50.9 | 0.3 | 0 | 0.5 | 27.8 | 0.3 | 0 |
| Nominal | 0 | 60.22 | 9.69 | 1.996 | 0.546 | 25.03 | 2.14 | 0.0116 |

As shown in Table 4, Na content in the surface of the bare glass was 2.7% and decreased with HNO₃ treatment regardless of treatment conditions. In particular, Na content maximally decreased to 0.3% in the glass boiled in 50% HNO₃ for 30 minutes. Al added in a small amount also showed the same decreasing tendency, and C elements existing in the surface were also greatly reduced.

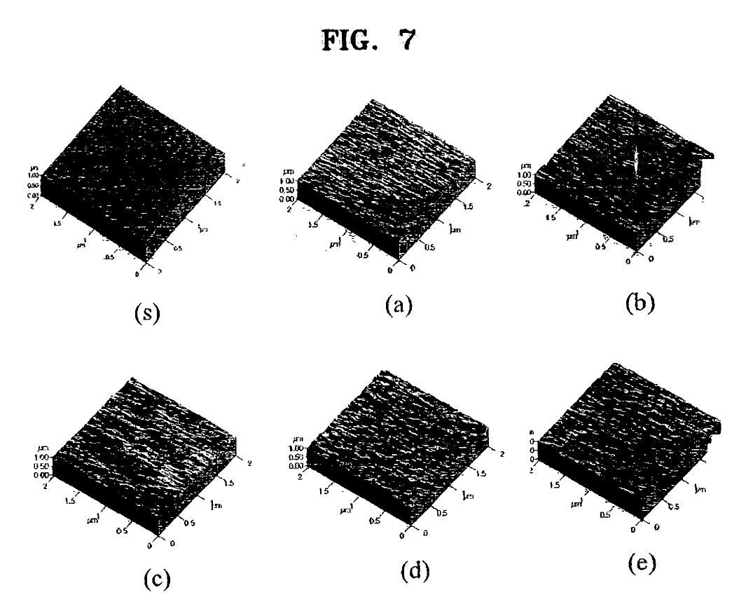

In order to study the structural change of the surface of chemically etched glass, AFM was employed. FIG. 7 shows three-dimensional (3D) images of a chemically etched glass surface, measured by an Atomic Force Microscope (AFM) usable in the atmosphere. As shown in FIG. 7, the glass samples treated with HNO₃ were etched so as to have considerably rough surfaces compared to bare glass.

While the Rₘₛ surface roughness, calculated from the 3D images shown in FIG. 7, of bare glass, that is, under the condition (s) was 0.58 nm, the Rₘₛ surface roughnesses of the glass samples under the conditions (a), (b), (c), (d) and (e) were 6.06 nm, 5.91 nm, 5.44 nm, 6.78 nm and 5.79 nm, respectively, that is, greatly increased compared to the case of the bare glass. However, the roughness change depending on the etching condition was negligible between each of the etched glass samples.

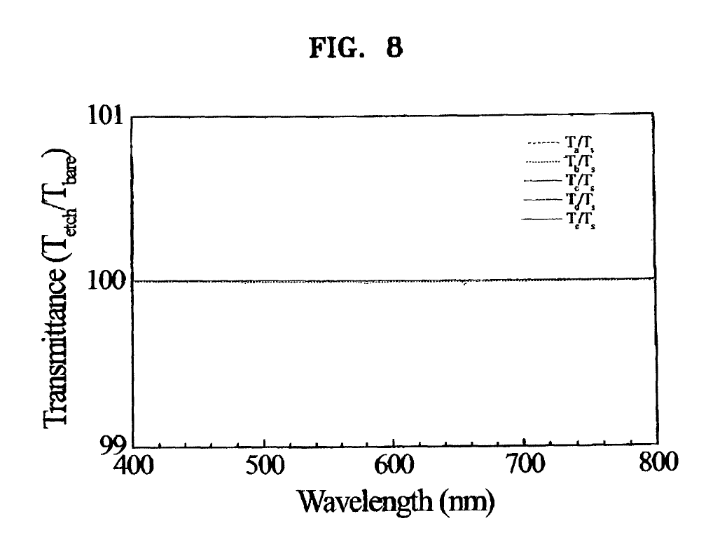

FIG. 8 shows the relative transmittance of bare glass and chemically etched glass samples with HNO₃ under the conditions (a), (b), (c), (d) and (e). As shown in FIG. 8, no HNO₃ treatment effects on the transmittance of glass revealed in the wavelength range of 400-800 nm.

In order to investigate thermal stability of the glass chemically etched with HNO₃, the compositional change of the glass surface was measured by XPS while performing 1 hour heat treatment on bare glass, that is, under the condition (s) and glass boiled in 70% HNO₃ for 30 minutes, that is, under the condition (e), at 300° C., 400° C., 500° C. and 600° C. in air.

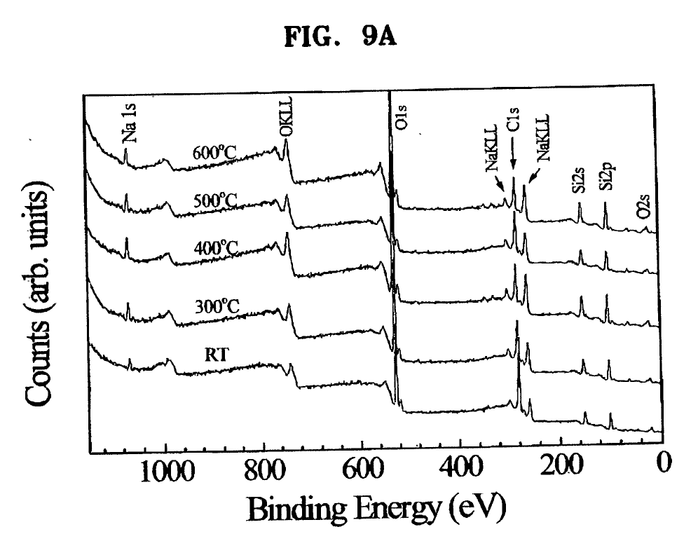

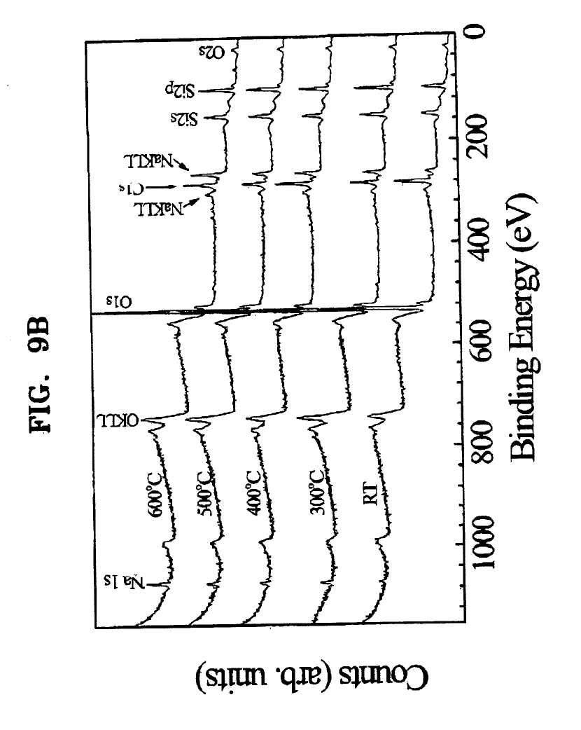

FIGS. 9A and 9B are XPS survey spectra depending on boiling temperatures of bare glass and glass chemically etched with 70% HNO₃ for 30 minutes, that is, under the condition (e). The magnitude of Na peak increased with an increase in the heat treatment temperature regardless of the treatment condition. However, the magnitude of the Na peak in the surface of the glass boiled in 70% HNO₃ for 30 minutes, that is, under the condition (e), was relatively smaller than that of the bare glass under the condition (s).

Tables 5 and 6 summarize compositional changes (represented by atomic percentage) of the surface of bare glass being under the condition (s) and the glass sample boiled in 70% HNO₃ for 30 minutes, that is, under the condition (e), estimated from XPS peaks using XPS sensitivity factors, depending on the annealing temperature, respectively.

TABLE 5
Chemical composition of bare glass with annealing temperature

| | C | O | Na | Mg | Al | Si | Ca | Fe |
|---|---|---|---|---|---|---|---|---|
| Room temperature | 54.5 | 29.2 | 2.7 | 0 | 1.2 | 12.6 | 0.3 | 0 |
| 300° C. | 40.5 | 39.7 | 3.6 | 0 | 1.3 | 14.9 | 0 | 0 |
| 400° C. | 26.9 | 46.3 | 5.6 | 0 | 1.1 | 19.8 | 0.4 | 0 |
| 500° C. | 35.7 | 41.3 | 4.6 | 0 | 1.1 | 16.7 | 0.7 | 0 |
| 600° C. | 25.8 | 48.6 | 4.3 | 0 | 1.1 | 19.9 | 0.4 | 0 |

As shown in Table 5, Na content in the surface of the bare glass under the condition (s) was 2.7% and Na elements were diffused into the surface with an increase in the temperature, resulting in an increase in the Na composition. Also, Na content was highest, that is, 5.6%, at 400° C., and then showed a decreasing tendency at a temperature higher than 400° C. This phenomenon may be due to evaporation of highly volatile Na elements, which have been out-diffused with an increase in the temperature.

TABLE 6
Compositional change in the glass boiled in 70% HNO₃ for
30 minutes depending on annealing temperature

| | C | O | Na | Mg | Al | Si | Ca | Fe |
|---|---|---|---|---|---|---|---|---|
| Room temperature | 35.9 | 43.6 | 1.2 | 0 | 0.2 | 19.1 | 0.1 | 0 |
| 300° C. | 21.0 | 52.2 | 2.7 | 0 | 0.2 | 23.9 | 0.1 | 0 |
| 400° C. | 30.8 | 45.7 | 2.6 | 0 | 0.5 | 20.0 | 0.5 | 0 |
| 500° C. | 20.0 | 53.1 | 2.8 | 0 | 0.3 | 23.5 | 0.3 | 0 |
| 600° C. | 25.0 | 50.1 | 4.6 | 0 | 0.3 | 19.6 | 0.4 | 0 |

As shown in Table 6, the glass boiled in 70% HNO₃ for 30 minutes, that is, under the condition (e), the Na composition relatively gently increased to 2.8% up to 500° C. Also, Al and Ca compositions were also relatively smaller in the glass boiled in 70% HNO₃ for 30 minutes regardless of heat treatment. In other words, alkali metal elements such as Na, Ca or Al, could be effectively extracted from the glass by boiling the glass with HNO₃ solution.

### EXAMPLE 3

Chemical Etching with Hydrochloric Acid (HCl)

The glass samples used in this experiment, that is, slide glass (Marienfeld o Co.), are glass substrates having a rectangular shape (0.2 mm×12 mm×12 mm) as in Examples 1 and 2. The glass substrates were chemically etched under the following conditions:

a: Boiling in 36% HCl solution for 30 minutes;

b: Ultrasonic treatment in 36% HCl solution for 30 minutes; and

c: Soaking in 36% HCl solution for 6 hours.

X-ray Photoelectron Spectroscopy (XPS) measurements were carried out to investigate a compositional change of glass depending on chemical etching conditions.

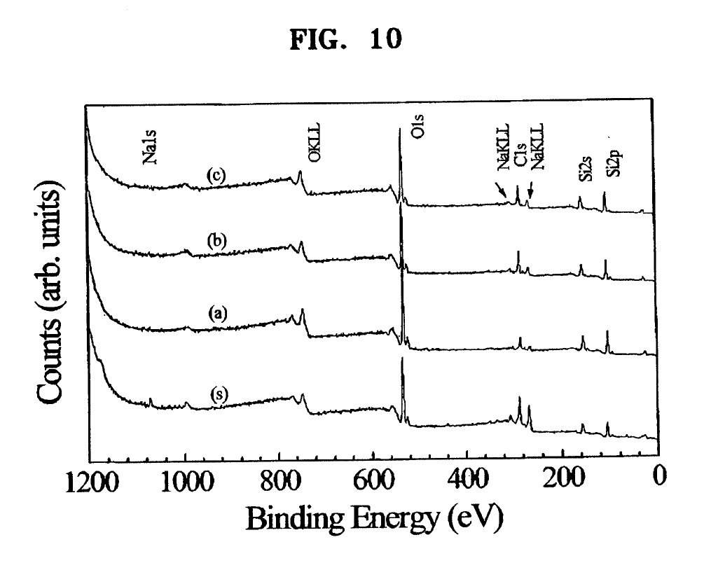

FIG. 10 is an X-ray Photoelectron Spectroscopy (XPS) spectrum showing the analysis results of compositions of the surfaces of bare glass and glass chemically etched under the above three conditions. As shown in FIG. 10, while the sample of bare glass (being under the condition (s)) showed higher peaks of sodium (Na) and carbon (C) relative to silicon (Si), all the samples chemically etched with HCl showed that the heights of C and Na peaks were greatly reduced. In particular, a very weak sodium signal was detected from the sample surface being under the condition (a) in which the sample was boiled in 36% HCl solution for 30 minutes.

Table 7 shows compositions (represented by atomic percentage) of the surfaces of bare glass and glass chemically etched with HCl, estimated from XPS peaks thereof using XPS sensitivity factors.

TABLE 7
Composition of glass surface depending on HCl treatment conditions

| | C | O | Na | Mg | Al | Si | Ca | Fe |
|---|---|---|---|---|---|---|---|---|
| No treatment | 52.5 | 29.2 | 2.7 | 0 | 1.2 | 12.6 | 0.3 | 0 |
| A | 15.1 | 54.1 | 0.2 | 0 | 0.4 | 29.8 | 0.3 | 0 |
| B | 27.1 | 45.0 | 1.2 | 0 | 0.7 | 25.1 | 0.5 | 0 |
| C | 25.3 | 47.1 | 0.9 | 0 | 0.9 | 25.6 | 0.2 | 0 |
| Nominal | 0 | 60.22 | 9.69 | 1.996 | 0.546 | 25.03 | 2.14 | 0.0116 |

As shown in Table 7, Na content in the surface of the bare glass was 2.7% and decreased with HCl treatment regardless of treatment conditions. In particular, Na content maximally decreased to 0.2% in the glass boiled in 36% HCl for 30 minutes. Al added in a small amount also showed the same decreasing tendency, and C elements existing in the surface were also greatly reduced.

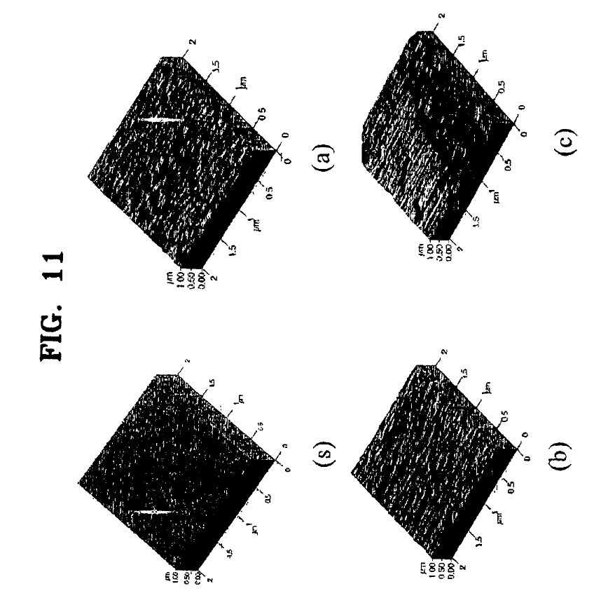

In order to study the structural change of the surface of chemically etched glass, AFM was employed. FIG. 11 shows three-dimensional (3D) images of the surfaces of glass samples chemically etched with HCl, measured by an Atomic Force Microscope (AFM) usable in the atmosphere. As shown in FIG. 11, the glass samples treated with HCl, under the conditions (a), (b) and (c), were etched so as to have considerably rough surfaces compared to bare glass under the condition (s).

While the Rₘₛ surface roughness, calculated from the 3D images shown in FIG. 11, of bare glass, that is, under the condition (s) was 0.58 nm, the Rₘₛ surface roughnesses of the glass samples under the conditions (a), (b) and (c) were 2.79 nm, 5.01 nm and 1.43 nm, respectively, that is, greatly increased compared to the case of the bare glass.

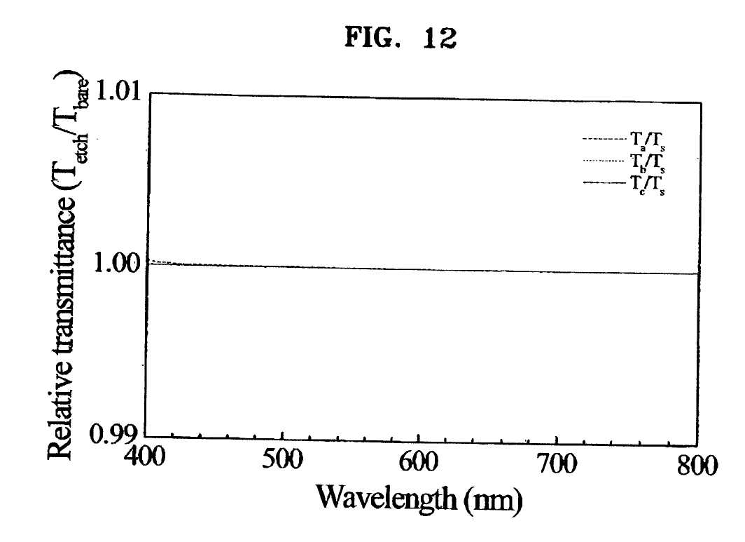

FIG. 12 shows the relative transmittance of bare glass and chemically etched glass samples with HCl. As shown in FIG. 12, no HCl treatment effects on the transmittance of glass revealed in the wavelength range of 400-800 nm.

In order to investigate thermal stability of the glass chemically etched with HCl, the compositional change of the glass surface was measured by XPS while performing 1 hour heat treatment in air on bare glass, that is, under the condition (s) and glass boiled in 36% HCl for 30 minutes, that is, under the condition (a), at 300° C., 400° C., 500° C. and 600° C.

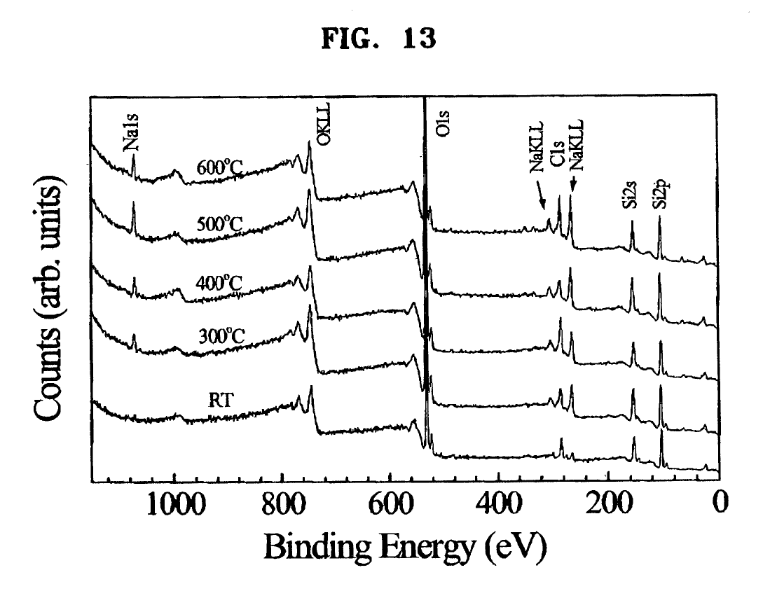

FIG. 13 is an XPS survey spectrum depending on boiling temperatures of bare glass and glass chemically etched with 36% HCl for 30 minutes, that is, under the condition (a). The magnitude of Na peak increased with an increase in the heat treatment temperature regardless of the treatment condition. However, the magnitude of the Na peak in the surface of the glass boiled in 36% HCl for 30 minutes, that is, under the condition (a), was relatively smaller than that of the bare glass under the condition (s).

Table 8 summarizes compositional changes (represented by atomic percentage) of the surface of glass samples boiled in 36% HCl for 30 minutes, estimated from XPS peaks using XPS sensitivity factors.

TABLE 8
Composition of glass boiled in 36% HCl for 30 minutes depending
on annealing temperature

| | C | O | Na | Mg | Al | Si | Ca | Fe |
|---|---|---|---|---|---|---|---|---|
| Room temperature | 15.1 | 54.1 | 0.2 | 0 | 0.4 | 30.0 | 0.3 | 0 |
| 300° C. | 12.5 | 53.7 | 3.6 | 0 | 0.5 | 29.1 | 0.5 | 0 |
| 400° C. | 23.6 | 50.0 | 3.6 | 0 | 0.5 | 22.1 | 0.3 | 0 |
| 500° C. | 7.3 | 59.9 | 6.3 | 0 | 0.5 | 25.5 | 0.5 | 0 |
| 600° C. | 18.2 | 53.6 | 4.5 | 0 | 0.5 | 25.5 | 0.5 | 0 |

As shown in Table 8, the glass boiled in 36% HCl for 30 minutes, that is, under the condition (a), the Na composition relatively gently increased to 3.6% up to 400° C. Also, Al and Ca compositions were also relatively smaller in the glass boiled in 36% HCl for 30 minutes regardless of heat treatment. In other words, alkali metal elements such as Na, Ca or Al, could be effectively extracted from the glass by boiling the glass with HCl solution.

As described above, in the Na extraction method according to the present invention, sodium elements in the glass surface can be effectively extracted by exposing glass to strong H₂SO₄, HNO₃ and HCl solutions. Since the glass treated with strong acid is more excellent in thermal stability with respect to sodium than bare glass, it is possible to effectively prevent a decrease in the adhesive strength between glass and a metal film, caused due to sodium elements existing in the glass surface, out-diffusion of sodium elements due to use of the glass at high temperatures, and a change in the characteristic of the deposited layer due to the reaction with the metal or compound such as TiO₂ or ITO (Indium Tin Oxide), deposited on the glass surface. Also, an adhesive strength between glass and metal can be improved and a change in the characteristics of a deposited layer due to diffusion of sodium elements can be prevented, at low cost, without a change in the characteristics of glass materials. Also, since the glass surface is etched after being wrapped by a patterned insulator tape, it can be partially etched in a desired pattern.

What is claimed is:

1. A method for extracting sodium (Na) elements from the surface of glass by etching the Na containing glass substrate with strong acid.

2. The method according to claim 1, wherein the strong acid is at least one selected from the group consisting of sulfuric acid (H₂SO₄), nitric acid (HNO₃) and hydrochloric acid (HCl).

3. The method according to claim 1, wherein the etching is performed by one of boiling, ultrasonic treatment and soaking.

4. The method according to claim 1, wherein the etching time is in the range of 10 seconds to 10 hours.

5. The method according to claim 1, wherein the concentration of the strong acid is in the range of 0.1 to 100% (w/w).

6. The method according to claim 1, wherein the treatment temperature ranges from room temperature to 500° C.

7. The method according to claim 3, wherein the ultrasonic treatment is performed for from 1 minute to 10 hours.

8. The method according to claim 1, wherein the surface of the glass substrate is wrapped using a patterned mask to partially etch a desired portion.
